(19) United States
(12) Patent Application Publication
(10) Pub. No.: US 2023/0090873 A1
(43) Pub. Date: Mar. 23, 2023

(54) COMMUNICATION APPARATUS AND COMMUNICATION SYSTEM

(71) Applicant: Sony Semiconductor Solutions Corporation, Kanagawa (JP)

(72) Inventors: Toshihisa Hyakudai, San Diego, CA (US); Junya Yamada, Kanagawa (JP); Satoshi Ota, Kanagawa (JP)

(21) Appl. No.: 17/933,644

(22) Filed: Sep. 20, 2022

Related U.S. Application Data
(60) Provisional application No. 63/246,507, filed on Sep. 21, 2021.

(51) Int. Cl. H04L 5/14; H04L 7/00

(52) U.S. Cl. CPC H04L 5/1469; H04L 7/0041

(57) ABSTRACT

To suppress EMI noise when performing serial transmission by a plurality of transmission cables.

A communication apparatus includes a plurality of communication units that transmits a plurality of first signals to a plurality of cables at different times and receives a plurality of second signals via the plurality of cables at different times, in a time division duplex (TDD) communication method.

### CROSS REFERENCE TO RELATED APPLICATIONS

This application claims the benefit of U.S. Priority Patent Application No. 63/246,507 filed on Sep. 21, 2021, the entire contents of which are incorporated herein by reference.

### TECHNICAL FIELD

The present disclosure relates to a communication apparatus and a communication system.

### BACKGROUND ART

A technique of performing high-speed serial communication via a transmission cable connected between a plurality of apparatuses has been proposed (PTL 1). This type of high-speed serial communication is used in various fields, and is also used for communication between in-vehicle equipment, for example.

### CITATION LIST

### Patent Literature

[PTL 1]
JP 2011-239011 A

### SUMMARY

### Technical Problem

The transmission capacity that can be transmitted by one transmission cable is limited, and in order to serially transmit a large amount of data at high speed, it is necessary to transmit a plurality of pieces of serial data simultaneously in parallel by a plurality of transmission cables.

However, when the logic of each signal on the plurality of transmission cables transition at the same time, electro magnetic interference (EMI) noise may occur.

Therefore, the present disclosure provides a communication apparatus and a communication system capable of suppressing EMI noise when performing serial transmission by a plurality of transmission cables.

### Solution to Problem

According to the present disclosure, there is provided a communication apparatus including a plurality of communication units that transmits a plurality of first signals to a plurality of cables at different times and receives a plurality of second signals via the plurality of cables at different times, in a time division duplex (TDD) communication method.

The plurality of communication units may cause timings to transmit the plurality of first signals to the plurality of cables to be different, and may cause timings to receive the plurality of second signals from the plurality of cables to be different.

Using a corresponding one of the cables, each of the plurality of communication units may transmit, in a first signal section, a corresponding one of the first signals, and receive, in a second signal section, a corresponding one of the second signals.

The plurality of communication units may sequentially shift the plurality of first signals by a predetermined time difference and transmit the plurality of first signals to the plurality of cables.

The predetermined time difference may be the same time difference.

The predetermined time difference may include two or more time differences having different time lengths.

A plurality of temporary storage units that adjusts variations in reception timing of the plurality of second signals received by the plurality of communication units may be included.

A storage capacity of each of the plurality of temporary storage units may vary according to signal propagation delay time of a corresponding one of the cables.

The plurality of temporary storage units may adjust variation in signal propagation delay time of the plurality of cables.

A measurer that measures signal propagation delay time of the plurality of cables may be included, the plurality of communication units may adjust transmission timing of the plurality of first signals to be transmitted to the plurality of cables on the basis of a measurement result of the measurer.

A precision time base (PTB) counter that generates time stamp information to be commonly used with a communication partner apparatus may be included,

the measurer may measure the signal propagation delay time of the plurality of cables in synchronization with the time stamp information.

The plurality of communication units may advance, to a larger degree, timing to transmit the corresponding first signal to the cable for a cable having a longer signal propagation delay time among the plurality of cables on the basis of a measurement result of the measurer.

According to the present disclosure, there is provided a communication apparatus including:

a plurality of communication units that transmits a plurality of first signals to a plurality of cables and receives a plurality of second signals by the plurality of cables, in a time division duplex (TDD) communication method,

in which the plurality of communication units includes a plurality of scramblers that generates the plurality of first signals in which timing at which logic of a plurality of transmission signals changes is randomized,

each of the plurality of scramblers includes

a first initial value setting unit that sets a first initial value different for each of the plurality of first signals,

a first random number generation unit that generates a first pseudo random number on the basis of the first initial value, and

a first logical operation unit that generates a corresponding one of the first signals by logical operation of the transmission signal that corresponds and the first pseudo random number that corresponds.

The first initial value setting unit may set the first initial value that is the same as an initial value that a communication partner apparatus that has received a corresponding one of the first signals uses to restore an original transmission signal.

The plurality of communication units may include a plurality of descramblers that performs decoding processing on the plurality of second signals, and

each of the plurality of descramblers may include

a second initial value setting unit that sets a second initial value different for each of the plurality of second signals,

a second random number generation unit that generates a second pseudo random number on the basis of the second initial value, and

a second logical operation unit that generates a corresponding reception signal by logical operation of a corresponding one of the second signals and the second pseudo random number that corresponds.

The second initial value setting unit may set the second initial value same as an initial value that a communication partner apparatus having transmitted a corresponding one of the second signals uses to generate the second signal.

According to the present disclosure, there is provided a communication system including:

a first communication apparatus; and

a second communication apparatus that alternately transmits and receives information to and from the first communication apparatus within a period allocated by a time division duplex (TDD) communication method,

in which each of the first communication apparatus and the second communication apparatus includes

a plurality of communication units that transmits a plurality of first signals to a plurality of cables at different times and receives a plurality of second signals via the plurality of cables at different times.

### BRIEF DESCRIPTION OF DRAWINGS

FIG. 1 is a block diagram illustrating a basic configuration of a communication apparatus and a communication system compliant with a high-speed interface standard ASA.

FIG. 2 is a view explaining a TDD communication method adopted in the ASA standard.

FIG. 3 is a block diagram illustrating internal configurations of Down link Tx and Up link Rx in two SerDes devices.

FIG. 4 is a block diagram illustrating an internal configuration of a scrambler in Down link Tx.

FIGS. 5A-B are block diagrams illustrating a schematic configuration of a communication apparatus and a communication system that perform serial transmission in parallel using four transmission cables.

FIG. 6 is a timing chart of Up link signals and Down link signals transmitted by four transmission cables.

FIG. 7 is a timing chart illustrating an example in which arrival time of each signal is shifted at an input end of PHY.

FIG. 8 is a view illustrating an example of transmission timings of Up link #1 to #4 signals and Down link #1 to #4 signals transmitted in four lanes corresponding to the four transmission cables.

FIG. 9 is a block indicating a part of an internal configuration of two SerDes devices according to a second embodiment.

FIG. 10 is a timing chart illustrating an example of controlling timings of a Down link signal and an Up link signal output from the PHY.

FIG. 11 is a view illustrating a connection relationship of each SerDes device illustrated in FIGS. 5A-B.

### DESCRIPTION OF EMBODIMENTS

Embodiments of a communication apparatus and a communication system according to the present disclosure will be described below with reference to the drawings. Although main configuration parts of the communication apparatus and the communication system will be mainly described below, the communication apparatus and the communication system may have configuration parts and functions that are not illustrated or described. The following description does not exclude configuration parts and functions that are not illustrated or described.

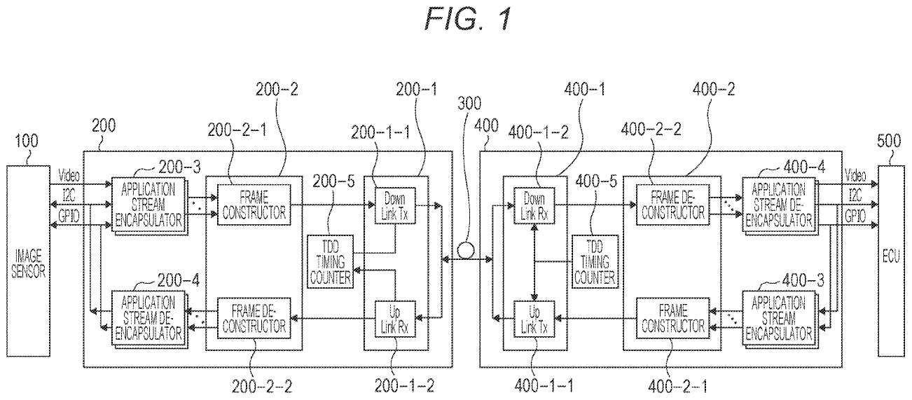

FIG. 1 is a block diagram illustrating a basic configuration of a communication apparatus and a communication system compliant with the high-speed interface standard automotive serdes alliance (ASA). The communication system of FIG. 1 includes two SerDes devices (200) and (400) connected by a transmission cable. These SerDes devices correspond to the communication apparatus of the present disclosure.

The SerDes device (200) includes PHY (200-1), LINK (200-2), an application stream encapsulator (200-3), an application stream de-encapsulator (200-4), and a TDD timing counter (200-5). The PHY (200-1) includes a Down link transmission unit (Down link Tx, 200-1-1) and an Up link Rx (200-1-2). The LINK (200-2) includes a frame constructor (200-2-1) and a frame de-constructor (200-2-2).

The SerDes device (400) includes PHY (400-1), LINK (400-2), an application stream encapsulator (400-3), an application stream de-encapsulator (400-4), and a TDD timing counter (400-5). The PHY (400-1) includes an Up link transmission unit (Up link Tx, 400-1-1) and a Down link Rx (400-1-2). The LINK (400-2) includes a frame constructor (400-2-1) and a frame de-constructor (400-2-2).

An image sensor (100) is connected to the SerDes device (200), and an ECU (500) is connected to the SerDes device (400). The communication system of FIG. 1 transmits a large-capacity video signal from the image sensor (100) at high speed from the SerDes device (200) to the SerDes device (400) via a transmission cable (300), and performs video processing and the like by the ECU (500) connected to the SerDes device (400). Furthermore, between the SerDes device (200) and the SerDes device (400), a control signal such as a GPIO signal and an I2C signal is simultaneously bidirectionally transmitted separately from a video signal.

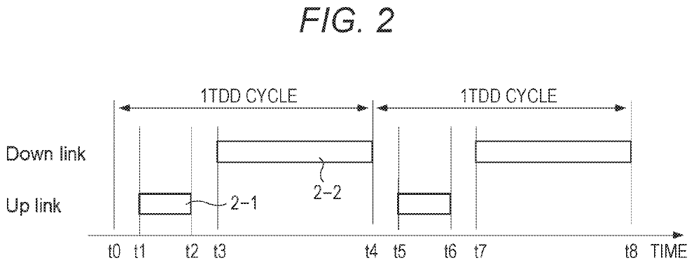

FIG. 2 is a view illustrating a time division duplex (TDD) communication method adopted in the ASA standard. As illustrated in FIG. 2, TDD communication is performed by dividing an Up link signal (2-1 in FIG. 2) output from the SerDes device (400) and a Down link signal (2-2 in FIG. 2) output from the SerDes device (200) into predetermined each signal section and alternately transmitting them. By adjusting the time width occupied by the Down link signal (2-2 in FIG. 2) output from the SerDes device (200), it is possible to time-divide and transmit a large-capacity video signal from the image sensor (100).

Furthermore, a no-signal section (t0 to t1 and t2 to t3 in FIG. 2) is provided for switching between the Up link signal (2-1 in FIG. 2) and the Down link signal (2-2 in FIG. 2), and this no-signal section can reduce an influence of propagation delay and reflection of the signals. This no-signal sections t0 to t1 and t2 to t3 have the same time width. As illustrated in FIG. 2, the no-signal section (t0 to t1), the Up link signal (t1 to t2), the no-signal section (t2 to t3), and the Down link signal (t3 to t4) are set as one TDD cycle, and TDD communication is performed by repeating a plurality of TDD cycles.

The switching timing of the Up link signal (2-1 in FIG. 2) and the Down link signal (2-2 in FIG. 2) is based on the TDD timing counter (400-5) of the SerDes device (400) illustrated in FIG. 1, for example. The TDD timing counter (200-5) of the SerDes device (200) is synchronized with the TDD timing counter (400-5) in the SerDes device (400), whereby the switching timing of the Up link signal (2-1 in FIG. 2) and the Down link signal (2-2 in FIG. 2) is controlled.

The TDD timing counters (400-5 and 200-5) repeatedly count one TDD cycle (modulo counter at time t4) with each other. It is assumed that clocks to be counted at this time are synchronized. The TDD timing counter (400-5) of the SerDes device (400) starts counting from time t0, controls the Up link Tx (400-1-1) at time t1, starts output of the Up link signal (2-1 in FIG. 2), and stops output at time t2. Thereafter, the TDD timing counter (400-5) controls the Down link Rx (400-1-2) from time t3 to time t4, that is, until the end of one TDD cycle, and causes reception processing of the Down link signal to be performed.

On the other hand, when the Up link Rx (200-1-2) starts to receive the Up link signal, the SerDes device (200) transmits the information to the TDD timing counter (200-5). The TDD timing counter (200-5) starts counting of one TDD cycle with the time as t1. The Up link Rx (200-1-2) is controlled until time t2 and reception processing of the Up link signal is caused to perform. Thereafter, the TDD timing counter (200-5) controls the Down link Tx (200-1-1) to start output of the Down link signal (2-2 in FIG. 2), outputs the Down link signal for a time width t3 to t4, and then stops output. By repeatedly performing such an operation, switching of the TDD signal is controlled.

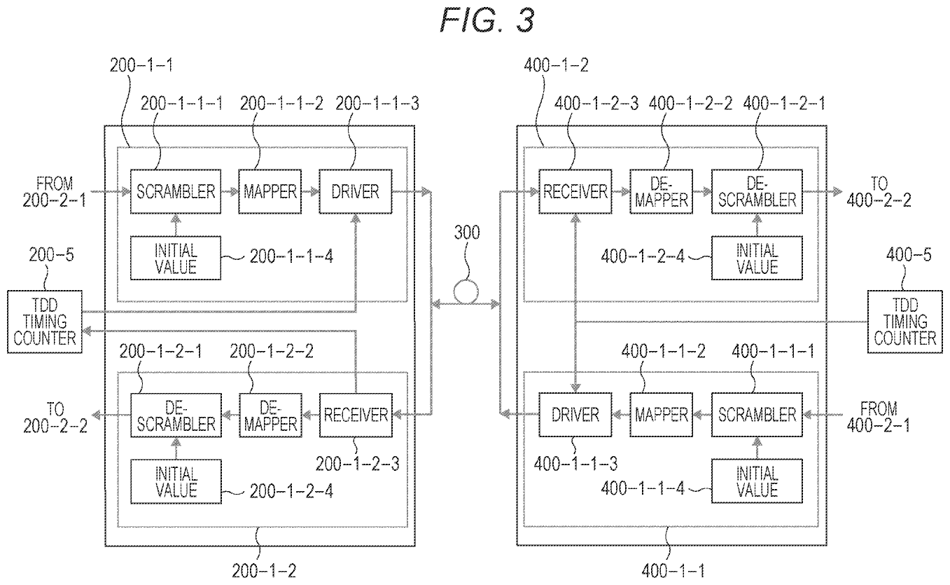

FIG. 3 is a block diagram illustrating internal configurations of the Down link Tx (200-1-1) and the Up link Rx (200-1-2) included in the PHY (200-1) of the SerDes device (200) of FIG. 1 and the Down link Rx (400-1-2) and the Up link Tx (400-1-1) included in the PHY (400-1) of the SerDes device (400).

The Down link Tx (200-1-1) includes a scrambler (200-1-1-1), a mapper (200-1-1-2), a driver (200-1-1-3), and an initial value register (200-1-1-4). The Up link Rx (200-1-2) includes a descrambler (200-1-2-1), a de-mapper (200-1-2-2), a receiver (200-1-2-3), and an initial value register (Initial value, 200-1-2-4).

The Up link Tx (400-1-1) includes a scrambler (400-1-1-1), a mapper (400-1-1-2), a driver (400-1-1-3), and an initial value register (400-1-1-4). The Down link Rx (400-1-2) includes a descrambler (400-1-2-1), a de-mapper (400-1-2-2), a receiver (400-1-2-3), and an initial value register (400-1-2-4). The above-described initial value registers (200-1-1-4, 200-1-2-4, 400-1-1-4, and 400-1-2-4) correspond to the initial value setting unit.

The internal configurations of the Down link Tx (200-1-1) and the Up link Tx (400-1-1) are the same. Similarly, the internal configurations of the Down link Rx (400-1-2) and the Up link Rx (200-1-2) are the same.

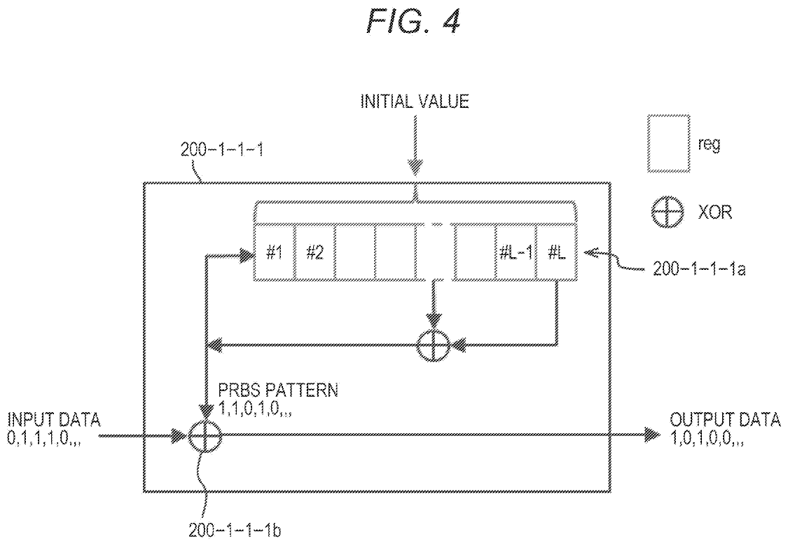

FIG. 4 is a block diagram illustrating an internal configuration of the scrambler (200-1-1-1) in the Down link Tx (200-1-1). As illustrated in FIG. 4, the scrambler (200-1-1-1) includes a pseudo random pattern generator (200-1-1-1a) and an XOR operator (200-1-1-1b). The pseudo random pattern generator (200-1-1-1a) generates a pseudo random number on the basis of the initial value. The XOR operator (200-1-1-1b) outputs a result of performing XOR operation between the pseudo random number generated by the pseudo random pattern generator (200-1-1-1a) and input data.

The operation of the Down link Tx (200-1-1) will be briefly described below. A frame-structured signal is input from the frame constructor (200-2-1) to the Down link Tx (200-1-1). The scrambler (200-1-1-1) in the Down link Tx (200-1-1) performs XOR operation of the signal from the frame constructor (200-2-1) and the pseudo random pattern, thereby performing processing of eliminating bias in an occurrence frequency of 0 and 1. Therefore, data reception on the reception side is made easy, and EMI characteristic can be improved by eliminating a signal configuration part having a specific frequency.

The initial value for generating the pseudo random pattern is stored in an initial value register (200-1-1-4) and is input to the pseudo random pattern generator of FIG. 4 at a certain specific timing at the start of signal transmission.

The signal output from the scrambler (200-1-1-1) is subjected to mapping processing according to a modulation method such as NRZ and PAM4 by the mapper (200-1-1-2). The mapped signal is output to the transmission cable (300) with a predetermined signal output by the driver (200-1-1-3). At this time, the output timing of the driver (200-1-1-3) is controlled by the TDD timing counter (200-5), and output is performed so as to match a predetermined one TDD cycle period.

Next, the operation of the Down link Rx (400-1-2) will be briefly described. The receiver (400-1-2-3) performs processing of equalizing transmission path distortion due to a transmission cable length and the like, determining data at an appropriate timing by a clock reproduction function, and receiving a signal from the Down link Tx (200-1-1) transmitted through the transmission cable (300). Output timing of the receiver (400-1-2-3) is controlled by the TDD timing counter (400-5), and the receiver (400-1-2-3) performs reception operation so as to match a predetermined TDD1 cycle period.

The de-mapper (400-1-2-2) restores the NRZ or PAM4 signal received by the receiver (400-1-2-3) to an original digital signal. The descrambler (400-1-2-1) performs the same processing as the scrambler (200-1-1-1) on the signal from the de-mapper (400-1-2-2). The internal configuration of the descrambler (400-1-2-1) is the same as that illustrated in FIG. 4, and inverse operation of the pseudo random pattern performed on the transmission side is performed by performing XOR operation with the pseudo random pattern on the received signal to restore the original data. At this time, the initial value for generating the pseudo random pattern is stored in the initial value register (400-1-2-4), and the value needs to be the same as the value stored in the initial value register (200-1-1-4) of the Down link Tx (200-1-1), and the timing at which the initial value is input to the pseudo random pattern generator needs to be the same as the timing performed by the scrambler (200-1-1-1). This is generally called synchronization processing of the scrambler. Output of the descrambler (400-1-2-1) is output to (400-2-2) that performs frame processing.

The frame de-constructor (400-2-2) takes out a packet structure for each application from the frame structure and outputs the packet structure to the corresponding application stream de-encapsulator (400-4), and each application stream de-encapsulator (400-4) decodes the packet structure into each application signal such as a video signal and an I2C signal and outputs the application signal as a predetermined signal. This is the signal flow from the SerDes device (200) to the SerDes device (400).

On the other hand, the signal flow of a control signal such as an I2C signal and a GPIO signal from the SerDes device (400) to the SerDes device (200) is the same processing as the above-described Down link processing, and thus description is omitted.

Due to an increase in the number of pixels and a frame rate required for the image sensor (100), a signal capacity of a video signal becomes larger. On the other hand, it is becoming more difficult to increase the capacity that can be transmitted by one transmission cable (300) due to the difficulty of compensating for waveform distortion by transmission loss caused by the transmission cable length. Therefore, transmission using a plurality of transmission cables (300) has been put into practical use and studied in various high-speed transmission standards.

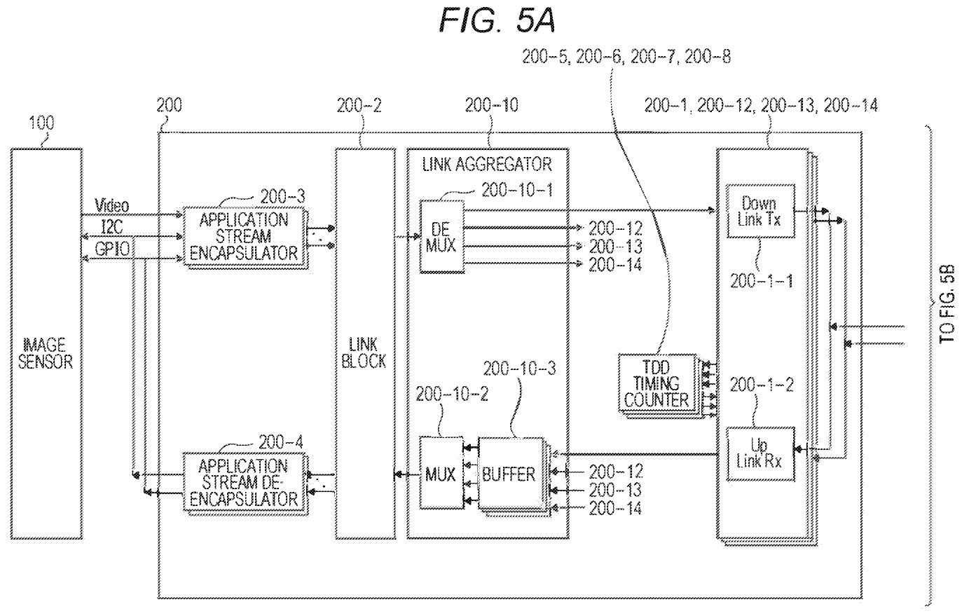

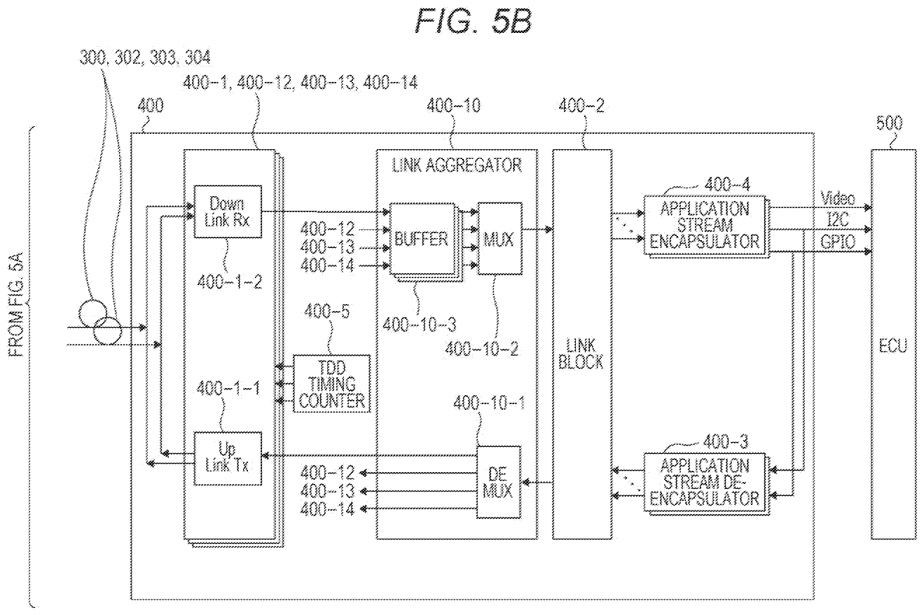

FIGS. 5A-B are block diagrams illustrating a schematic configuration of the communication apparatus and the communication system that perform serial transmission in parallel using four transmission cables (300, 302, 303, and 304). In FIGS. 5A-B, the same configuration parts common in those in FIG. 1 are denoted by the same reference numerals, and differences will be mainly described below.

The communication system in FIGS. 5A-B includes the SerDes device (200) and the SerDes device (400) connected to the plurality of transmission cables (300, 302, 303, and 304). The SerDes device (200) includes a plurality of PHYs (200-1, 200-12, 200-13, and 200-14) connected to the plurality of transmission cables (300, 302, 303, and 304), a LINK 200-2, a plurality of application stream encapsulators (200-3), a plurality of application stream de-encapsulators (200-4), a plurality of TDD timing counters (200-5, 200-6, 200-7, and 200-8), and a LINK aggregator (200-10). The LINK aggregator (200-10) includes a demultiplexer (200-10-1), a multiplexer (200-10-2), and a plurality of buffer memories (200-10-3).

The SerDes device (400) includes a plurality of PHYs (400-1, 400-12, 400-13, and 400-14) connected to the plurality of transmission cables (300, 302, 303, and 304), a LINK 400-2, a plurality of application stream encapsulators (400-3), a plurality of application stream de-encapsulators (400-4), a TDD timing counter (400-5), and a LINK aggregator (400-10). The LINK aggregator (400-10) includes a demultiplexer (400-10-1), a multiplexer (400-10-2), and a plurality of buffer memories (400-10-3).

The PHYs (200-12, 200-13, and 200-14) have the same configuration as that of the PHY (200-1) and are connected to the corresponding transmission cables (300, 302, 303, and 304). Similarly, the PHYs (400-12, 400-13, and 400-14) have the same configuration as that of the PHY (400-1) and are connected to the corresponding transmission cables (300, 302, 303, and 304). While the number of transmission cables (300, 302, 303, and 304) is not limited, an example of four transmission cables (300, 302, 303, and 304) will be described below.

The TDD timing counters (200-5, 200-6, 200-7, and 200-8) are connected to the PHYs (200-1, 200-12, 200-13, and 200-14). The operation thereof is the same as that of the TDD timing counter (200-5) in FIG. 1 described above.

A frame-structured signal including a video signal from the LINK (200-2) is input to the LINK aggregator (200-10). The input signal is supplied to the PHYs (200-1, 200-12, 200-13, and 200-14) in units of frames by the demultiplexer (200-10-1). The processing in the PHYs (200-1, 200-12, 200-13, and 200-14) is the same as that in the PHY (200-1) in FIG. 1, and the processed signals are output to the transmission cables (300, 302, 303, and 304) as Down link signals #1, #2, #3, and #4, respectively.

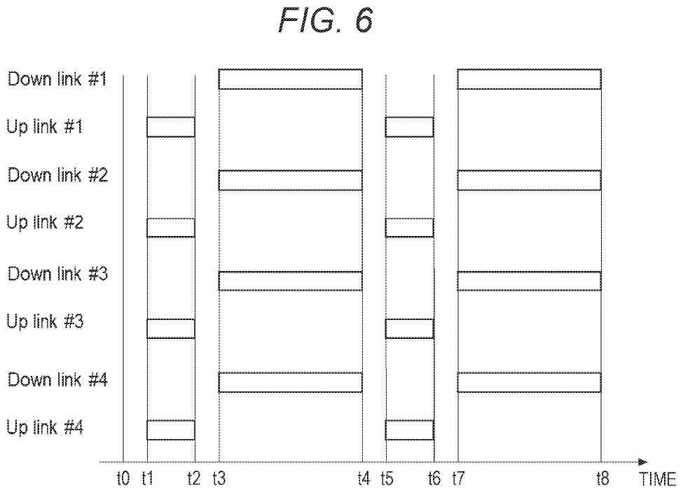

FIG. 6 is a timing chart of Up link signals and Down link signals transmitted by the four transmission cables (300, 302, 303, and 304). As illustrated, ideally, four Up link signals are transmitted at the same timing, and similarly, four Down link signals are transmitted at the same timing.

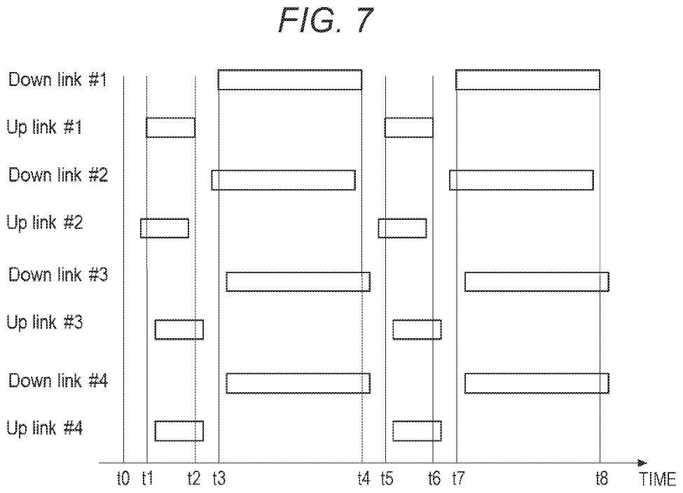

In a case where the lengths of the transmission cables (300, 302, 303, and 304) do not completely coincide with one another, propagation delays are different, and therefore arrival time of each signal is shifted at the input end of the PHYs (400-1, 400-12, 400-13, and 400-14) as illustrated in FIG. 7. This is generally called inter-lane skew.

The Down link signals #1, #2, #3, and #4 are input to the PHYs (400-1, 400-12, 400-13, and 400-14), and are subjected to the same processing as the Down link Rx (400-1-2) by the Down link Rx of each PHY, and then are output to the LINK aggregator (400-10).

The LINK aggregator (400-10) temporarily accumulates the signals from the PHYs (400-1, 400-12, 400-13, and 400-14) in each buffer memory (400-10-3). Each buffer memory (400-10-3) compensates for the inter-lane skew illustrated in FIG. 7 and eliminates the time difference among the Down link signals #1, #2, #3, and #4, thereby aligning the time of all the Down link signals as illustrated in FIG. 6 and outputting the signals to the multiplexer (400-10-2). The multiplexer (400-10-2) performs reverse processing of the processing performed by the demultiplexer (200-10-1) of the SerDes device (200), rearranges the frame signals in order of the PHYs (400-1, 400-12, 400-13, and 400-14), and outputs the frame signals to the LINK (400-2). Since subsequent processing is the same as that in FIG. 1, description is omitted. The signal flow of the control signals such as the I2C signal and the GPIO signal from the SerDes device (400) to the SerDes device (200) is the same processing as the above-described Down link processing similarly to the description in FIG. 1, and thus, the description is omitted.

The switching operation of the TDD signals of the plurality of lanes is performed by the TDD timing counter (400-5) and the TDD timing counters (200-5, 200-6, 200-7, and 200-8) similarly to the description of FIG. 1, and the control signal of each TDD timing counter is output to each of the plurality of PHYs.

In a case where the TDD signal is transmitted using a plurality of lanes as illustrated in FIG. 5, the Down link signal and the Up link signal repeat ON/OFF simultaneously as illustrated in FIG. 6. In this case, there is a case where the power source greatly swings due to ON/OFF of the signal. This may cause unnecessary radiation. Furthermore, in a case where the SerDes device includes analog processing, the SerDes device may serve as a noise source and hinder the analog processing.

Furthermore, since unlike a video signal, the I2C signal or the GPIO signal transmitted from the ECU (500) to the image sensor (100) using the Up link does not require a band using a plurality of lanes, it is assumed that the Up link output of the PHYs (400-1, 400-12, 400-13, and 400-14) only sends a dummy signal. In this case, even after the scrambler processing, the same signal may be output from the PHY, and in a case where signals of the same phase are output in a plurality of lanes, it is expected that unnecessary radiation will be caused similarly to described above. The communication apparatus and the communication system according to the present disclosure described below can suppress unnecessary radiation when performing signal transmission in a plurality of lanes.

### First Embodiment

The communication apparatus and the communication system according to the first embodiment have a block configuration similar to that in FIG. 5. The SerDes devices (200 and 400) in FIG. 5 correspond to the communication apparatus according to the first embodiment. Processing operations of the communication apparatus and the communication system according to the first embodiment will be described below with reference to FIG. 5.

In the first embodiment, the PHYs (200-1, 200-12, 200-13, and 200-14) in the SerDes device (200) of FIG. 5 transmit the Down link signals of the plurality of lanes to the plurality of transmission cables (300, 302, 303, and 304) at different times. Similarly, the PHYs (400-1, 400-12, 400-13, and 400-14) in the SerDes device (400) transmit the Up link signals of the plurality of lanes to the plurality of transmission cables (300, 302, 303, and 304) at different times. That is, the PHYs (200-1, 200-12, 200-13, and 200-14) make the timings to transmit the Down link signals to the plurality of transmission cables (300, 302, 303, and 304) different from one another, and make the timings to receive the plurality of Up link signals from the plurality of transmission cables (300, 302, 303, and 304) different from one another. Similarly, the PHYs (400-1, 400-12, 400-13, and 400-14) make the timings to transmit the Up link signals to the plurality of transmission cables (300, 302, 303, and 304) different from one another, and make the timings to receive the plurality of Down link signals from the plurality of transmission cables (300, 302, 303, and 304) different from one another.

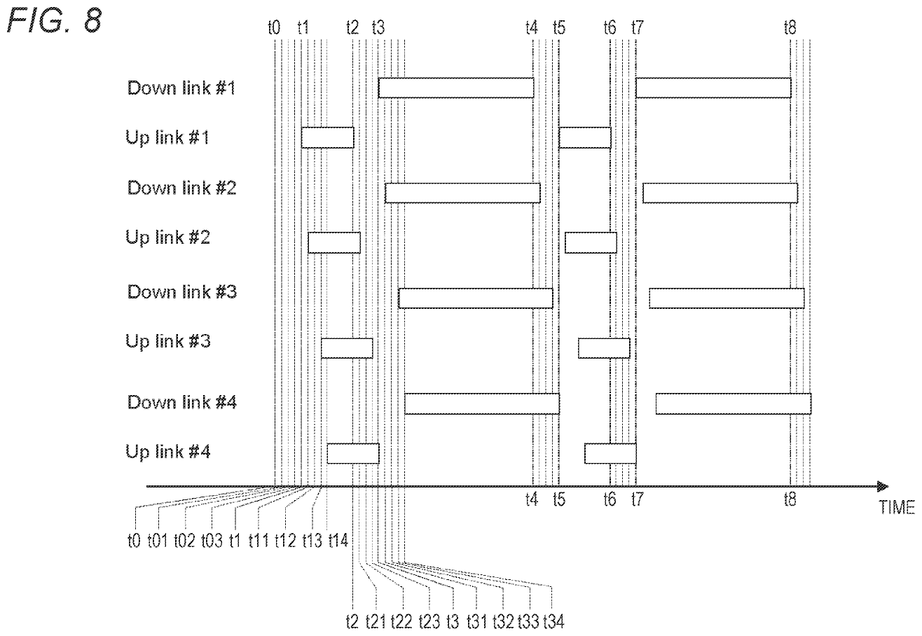

FIG. 8 is a view illustrating an example of transmission timing of Up link #1 to #4 signals and Down link #1 to #4 signals transmitted in the four lanes corresponding to the four transmission cables (300, 302, 303, and 304). FIG. 8 illustrates an example of first transmitting the Up link #1 signal output from the Up link Tx (400-1-1) of the PHY (400-1) at time t1.

Times t0, t1, t2 . . . , and t8 in FIG. 8 indicate the same times as the times illustrated in FIGS. 2, 6, and 7. Furthermore, times such as t01, t02, t03, t11, and t12 indicate times in which the no-signal sections (t0 to t1) and (t2 to t3) are divided into four sections.

The TDD timing counter (400-5) of the SerDes device (400) repeatedly counts one TDD cycle from t0 to t4 (modulo counter of t4).

When the TDD timing counter (400-5) is at time t1, the TDD timing counter (400-5) controls the Up link Tx (400-1-1) of the PHY (400-1) and causes the Up link #1 to be output. When the TDD timing counter (400-5) is at time t11, the TDD timing counter (400-5) controls the Up link Tx (400-12-1) of the PHY (400-12) and causes the Up link #2 to be output. When the TDD timing counter (400-5) is at time t13, the TDD timing counter (400-5) controls the Up link Tx (400-13-1) of the PHY (400-13) and causes the Up link #3 to be output. When the TDD timing counter (400-5) is at time t14, the TDD timing counter (400-5) controls the Up link Tx (400-14-1) of the PHY (400-14) and causes the Up link #4 to be output.

Furthermore, when the TDD timing counter (400-5) is at time t2, the TDD timing counter (400-5) controls the Up link Tx (400-1-1) of the PHY (400-1) to stop the Up link #1. When the TDD timing counter (400-5) is at time t21, the TDD timing counter (400-5) controls the Up link Tx (400-12-1) of the PHY (400-12) to stop the Up link #2. When the TDD timing counter (400-5) is at time t23, the TDD timing counter (400-5) controls the Up link Tx (400-13-1) of the PHY (400-13) to stop the Up link #3. When the TDD timing counter (400-5) is at time t3, the TDD timing counter (400-5) controls the Up link Tx (400-14-1) of the PHY (400-14) to stop the Up link #4. These operations are repeatedly performed in the TDD cycle.

On the other hand, when the SerDes device (200) receives reception start timing information of the Up link signals received by the PHYs (200-1, 200-12, 200-13, and 200-14) to which the TDD timing counters (200-5, 200-6, 200-7, and 200-8) are connected, each of the TDD timing counters (200-5, 200-6, 200-7, and 200-8) counts the TDD cycle with the time as t1.

Each of the TDD timing counters (200-5, 200-6, 200-7, and 200-8) controls the Up link Rx (200-1-2) to which each is connected and causes reception processing of the Up link signal to be performed until time t2. Thereafter, the Down link Tx (200-1-1) to which each is connected is controlled to start output of the Down link signal, the Down link signal is output for the time width t3 to t5, and then the output is stopped.

By the above operation, the Up link signals #1, #2, #3, and #4 output with a temporal shift are received, and each Down link signal is output with reference to it, whereby the Down link signals can be output with a temporal shift.

The times at which the Down link #1, #2, #3, and #4 signals and the Up link #1, #2, #3, and #4 signals are transmitted to the transmission cables (300, 302, 303, and 304) may be shifted by the same time or may be shifted by different times. For example, the PHYs (200-1, 200-12, 200-13, and 200-14) transmit the plurality of Down link signals to the plurality of transmission cables (300) while sequentially shifting the plurality of Down link signals by a predetermined time difference. The predetermined time difference may be the same time difference or may include two or more time differences having different time lengths.

As described above, in the communication apparatus and the communication system according to the first embodiment, when the Up link signal and the Down link signal are transmitted between the SerDes device (200) and the SerDes device (400) by the TDD communication method, the Up link signals of the plurality of lanes are transmitted with time shifted, and the Down link signals of the plurality of lanes are transmitted with time shifted. Therefore, the signal logic of the plurality of Up link signals transmitted in the plurality of lanes does not change at the same timing, and similarly, the signal logic of the plurality of Down link signals does not change at the same timing. Therefore, EMI noise can be suppressed.

### Second Embodiment

As illustrated in FIG. 5, even if the plurality of transmission cables (300, 302, 303, and 304) connected between the SerDes device (200) and the SerDes device (400) are manufactured to have the same length, there is a possibility that a deviation occurs in a signal propagation delay time (PD) due to manufacturing variation and the like. When the output delay time is determined without considering the transmission cable length, it is assumed to exceed the capacity of the buffer memory (200-10-3) of the LINK aggregators (200-10 and 400-10). In order to reduce the capacity of the buffer memory (200-10-3), the output timing of the PHY connected to the transmission cable having a small propagation delay is only required to be delayed, and the output timing of the PHY connected to the transmission cable having a large propagation delay is only required to be advanced.

Therefore, a communication apparatus (SerDes (200 and 400)) according to the second embodiment measures signal propagation delay time of the plurality of transmission cables (300, 302, 303, and 304).

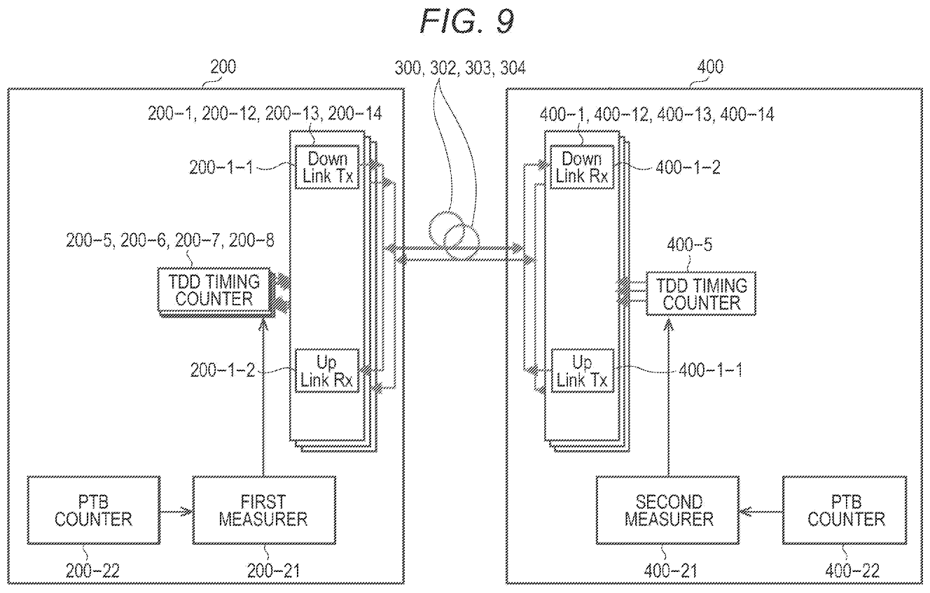

FIG. 9 is a block diagram illustrating a part of internal configurations of the SerDes (200) and the SerDes device (400) according to the second embodiment. The SerDes device (200) of FIG. 9 has a first measurer 200-21 in addition to having the same internal configuration as that of the SerDes device (200) of FIG. 5. The first measurer 200-21 measures the signal propagation delay time of the plurality of transmission cables (300, 302, 303, and 304).

The PHYs (200-1, 200-12, 200-13, and 200-14) in the SerDes device (200) adjusts the transmission timing of the Down link signal to be transmitted to the plurality of transmission cables (300, 302, 303, and 304) on the basis of the measurement result of the first measurer 200-21. For example, the PHYs (200-1, 200-12, 200-13, and 200-14) advances the timing of transmitting the corresponding Down link signal to the transmission cable as the transmission cable has a longer signal propagation delay time among the plurality of transmission cables (300, 302, 303, and 304) on the basis of the measurement result of the first measurer 200-21. The measurement result of the first measurer 200-21 is input to the TDD timing counters (200-5, 200-6, 200-7, and 200-8).

Similarly, the SerDes device (400) of FIG. 9 has a second measurer 400-21 in addition to having the same internal configuration as that of the SerDes device (400) of FIG. 5. The second measurer 400-21 measures the signal propagation delay time of the plurality of transmission cables (300, 302, 303, and 304). The measurement result of the second measurer 400-21 is input to the TDD timing counter (400-5).

The PHYs (400-1, 400-12, 400-13, and 400-14) in the SerDes device (400) adjusts the transmission timing of the Up link signal to be transmitted to the plurality of transmission cables (300, 302, 303, and 304) on the basis of the measurement result of the second measurer 400-21. For example, the PHYs (400-1, 400-12, 400-13, and 400-14) advances the timing of transmitting the corresponding Up link signal to the transmission cable as the transmission cable has a longer signal propagation delay time among the plurality of transmission cables (300, 302, 303, and 304) on the basis of the measurement result of the second measurer 400-21.

The SerDes device (200) and the SerDes device (400) in FIG. 9 may have PTB counters 200-22 and 400-22. The PTB counters 200-22 and 400-22 generate PTB time stamp information defined in the ASA standard. In the ASA standard, transmission of PTB time stamp information, which is clock information common among connected ASA devices, is standardized. Furthermore, in the ASA, by using PTB time stamp information, a device configured to obtain propagation delay information among connected ASA devices is standardized.

The SerDes device (200) and the SerDes device (400) that conform to the ASA standard measure signal propagation delay time of the plurality of transmission cables (300, 302, 303, and 304) in synchronization with PTB time stamp information.

The PHYs (200-1, 200-12, 200-13, and 200-14) in FIG. 9 acquire the signal propagation delay time of the plurality of transmission cables (300, 302, 303, and 304) measured by the first measurer 200-21, and determines the output timing of the plurality of Down link signals. Similarly, the PHYs (400-1, 400-12, 400-13, and 400-14) acquire the signal propagation delay time of the plurality of transmission cables (300, 302, 303, and 304) measured by the second measurer 400-21, and determines the output timing of the plurality of Up link signals. For example, in a case where the signal propagation delay time of the transmission cable (300, 302, 303, and 304) increases in the order of the transmission cables (304), (300), (303), and (302), four Up link signals are output in the order of the Up links #2, #3, #1, and #4.

Similarly, the TDD timing counters (200-5), (200-6), (200-7), and (200-8) of the SerDes device (200) can also adjust the Downlink output timing by using the propagation delay information by the PTB time stamp information.

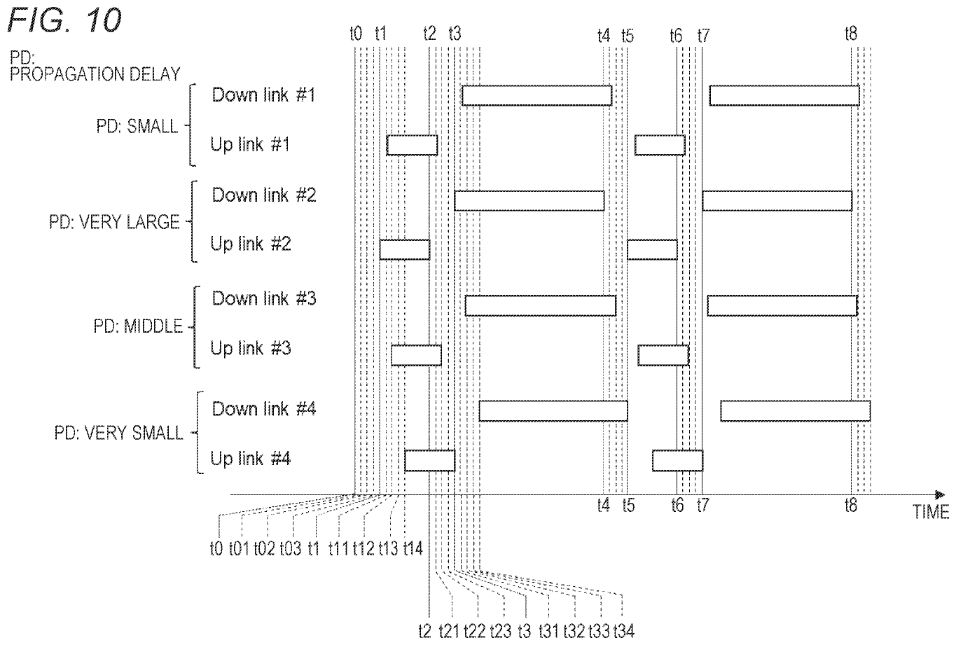

FIG. 10 is a timing chart illustrating an example in which the timing of the Down link signal output from the PHYs (200-1, 200-12, 200-13, and 200-14) is controlled on the basis of the measurement result of the first measurer 200-21, and the timing of the Up link signal output from the PHYs (400-1, 400-12, 400-13, and 400-14) is controlled on the basis of the measurement result of the second measurer 400-21.

FIG. 10 illustrates an example in which the signal propagation delay time of the transmission cable (300, 302, 303, and 304) increases in the order of the transmission cables (304), (300), (303), and (302). In this case, the PHYs (200-1, 200-12, 200-13, and 200-14) output the Down link #2, #1, #3, and #4 signals in this order, and the PHYs (400-1, 400-12, 400-13, and 400-14) output the Up link #2, #1, #3, and #4 signals in this order.

As described above, in the second embodiment, the output timing of the four Down link signals output from the PHYs (200-1, 200-12, 200-13, and 200-14) is controlled on the basis of the measurement results of the signal propagation delay time of the plurality of transmission cables (300, 302, 303, and 304), and the output timing of the four Down link signals output from the PHYs (400-1, 400-12, 400-13, and 400-14) is controlled, whereby the storage capacity of the buffer memories (200-10-3 and 400-10-3) for adjusting the signal propagation delay time can be reduced.

### Third Embodiment

In a third embodiment, an initial value given to a scrambler that randomizes timing at which signal logic of a plurality of Down link signals and a plurality of Up link signals transmitted in a plurality of lanes changes is made different for every lane.

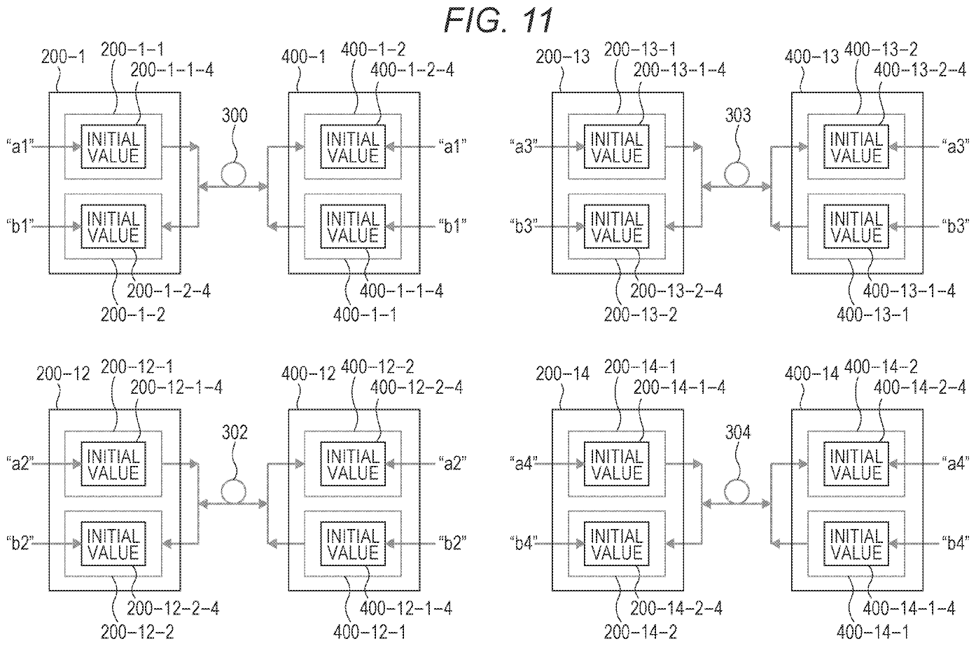

FIG. 11 is a view illustrating a connection relationship between the PHYs (200-1, 200-12, 200-13, and 200-14) in the four SerDes devices 200 and the PHYs (400-1, 400-12, 400-13, and 400-14) in the four SerDes devices 400 illustrated in FIG. 5. As illustrated, the PHY (200-1) and the PHY (400-1) are connected via the transmission cable (300). Furthermore, the PHY (200-12) and the PHY (400-12) are connected via the transmission cable (302). Furthermore, the PHY (200-13) and the PHY (400-13) are connected via the transmission cable (303). Furthermore, the PHY (200-14) and the PHY (400-14) are connected via the transmission cable (304).

The PHYs (200-1, 200-12, 200-13, and 200-14) in the four SerDes devices 200 basically have an internal configuration similar to that of the SerDes device (200) in FIG. 5, but the four Down links Tx (200-1-1, 200-12-1, 200-13-1, and 200-14-1) in the PHYs (200-1, 200-12, 200-13, and 200-14) in FIG. 11 have first initial value setting units (200-1-1-4, 200-12-1-4, 200-13-1-4, and 200-14-1-4), respectively, and of the Up links Rx (200-1-2, 200-12-2, 200-13-2, and 200-13-3) have second initial value setting units (200-1-2-4, 200-12-2-4, 200-13-2-4, and 200-14-2-4), respectively.

The first initial value setting units (200-1-1-4, 200-12-1-4, 200-13-1-4, and 200-14-1-4) set a different first initial value for each of the four Down link signals. The second initial value setting units (200-1-2-4, 200-12-2-4, 200-13-2-4, and 200-14-2-4) set a different second initial value for each of the four Up link signals. The first initial value and the second initial value are given from a register or a controller (not illustrated).

Each of the four Down link Tx (200-1-1, 200-12-1, 200-13-1, and 200-14-1) includes the scrambler 200-1-1-1 having a configuration similar to that in FIG. 4. Each scrambler 200-1-1-1 generates a first pseudo random number on the basis of the corresponding first initial value, and generates a corresponding Down link signal by logical operation of the corresponding Down link signal and the first pseudo random number.

More specifically, the scrambler 200-1-1-1 in the Down link Tx (200-1-1, 200-12-1, 200-13-1, and 200-14-1) includes the first initial value setting units (200-1-1-4, 200-12-1-4, 200-13-1-4, and 200-14-1-4) illustrated in FIG. 11, the first random number generation unit (pseudo random number pattern generator (200-1-1-1a)) illustrated in FIG. 4, and the first logical operation unit (XOR operator (200-1-1-1b)) illustrated in FIG. 4. The first random number generation unit (200-1-1-1a) generates a first pseudo random number on the basis of the first initial value. The first logical operation unit (200-1-1-1b) generates a corresponding Down link signal (first signal) by logical operation of the corresponding transmission signal and the corresponding first pseudo random number.

Similarly, each of the four Up link Rx (400-1-1, 400-12-1, 400-13-1, and 400-14-1) includes the descrambler 200-1-2-1 having a configuration similar to that in FIG. 4. Each descrambler 200-1-2-1 generates a second pseudo random number on the basis of the corresponding second initial value, and generates an original transmission signal by logical operation of the corresponding Up link signal and the second pseudo random number.

More specifically, the descrambler 200-1-2-1 in the Up link Rx (400-1-1, 400-12-1, 400-13-1, and 400-14-1) includes the second initial value setting units (200-1-2-4, 200-12-2-4, 200-13-2-4, and 200-14-2-4) illustrated in FIG. 11, the second random number generation unit (pseudo random number pattern generator (200-1-1-1a)) illustrated in FIG. 4, and the second logical operation unit (XOR operator (200-1-1-1b)) illustrated in FIG. 4. The second random number generation unit (200-1-1-1a) generates a second pseudo random number on the basis of the second initial value. The second logical operation unit (200-1-1-1b) restores the corresponding original transmission signal by logical operation of the corresponding Up link signal and the corresponding second pseudo random number.

In the pair of Down link Tx (200-1-1, 200-12-1, 200-13-1, and 200-14-1) and Down link Rx (400-1-2, 400-12-2, 400-13-2, and 400-14-2), the initial value of the same value is set. However, different Down link Tx sets a different initial value. For example, the initial value in the initial value register (200-1-1-4) of the Down link Tx (200-1-1) of the PHY (200-1) and the initial value in the initial value register (400-1-2-4) of the Down link Rx (400-1-2) of the PHY (400-1) of the same pair are matched by “a1”. On the other hand, the initial value in the initial value register (200-1-14-4) of the Down link Tx (200-14-1) of the PHY (200-14) and the initial value in the initial value register (400-14-2-4) of the Down link Rx (400-14-2) of the PHY (400-14) are “a4” and is an initial value of a different value.

Similarly, the initial values of the scrambler and the descrambler in the Up link Tx (400-1-1, 400-12-1, 400-13-1, and 400-14-1) and the Up link Rx (200-1-2, 200-12-2, 200-13-2, and 200-14-2) that are paired are matched. On the other hand, the initial values of the scrambler and the descrambler in another pair of Up link Tx and Up link Rx are different values from each other.

As described above, in the third embodiment, by changing the initial values of the scrambler and the descrambler for each pair of the Down link Tx (200-1-1, 200-12-1, 200-13-1, and 200-14-1) and the Down link Rx (400-1-2, 400-12-2, 400-13-2, and 400-14-2) and for each pair of the Up link Tx (400-1-1, 400-12-1, 400-13-1, and 400-14-1) and the Up link Rx (200-1-2, 200-12-2, 200-13-2, and 200-14-2), even in a case where signals are transmitted in a plurality of lanes at the same timing and signals are received in a plurality of lanes at the same timing, the patterns of the signals do not become the same, which can contribute to EMI reduction.

Note that the present technology can have the following configurations.

(1) A communication apparatus including a plurality of communication units that transmits a plurality of first signals to a plurality of cables at different times and receives a plurality of second signals via the plurality of cables at different times, in a time division duplex (TDD) communication method.

(2) The communication apparatus according to (1), in which the plurality of communication units causes timings to transmit the plurality of first signals to the plurality of cables to be different, and causes timings to receive the plurality of second signals from the plurality of cables to be different.

(3) The communication apparatus according to (1) or (2), in which, using a corresponding one of the cables, each of the plurality of communication units transmits, in a first signal section, a corresponding one of the first signals, and receives, in a second signal section, a corresponding one of the second signals.

(4) The communication apparatus according to any one of (1) to (3), in which the plurality of communication units sequentially shifts the plurality of first signals by a predetermined time difference and transmits the plurality of first signals to the plurality of cables.

(5) The communication apparatus according to (4), in which the predetermined time difference is a same time difference.

(6) The communication apparatus according to (4), in which the predetermined time difference includes two or more time differences having different time lengths.

(7) The communication apparatus according to any one of (1) to (6), further including: a plurality of temporary storage units that adjusts variations in reception timing of the plurality of second signals received by the plurality of communication units.

(8) The communication apparatus according to (7), in which a storage capacity of each of the plurality of temporary storage units varies according to signal propagation delay time of a corresponding one of the cables.

(9) The communication apparatus according to (7) or (8), in which the plurality of temporary storage units adjusts variation in signal propagation delay time of the plurality of cables.

(10) The communication apparatus according to any one of (1) to (9), further including:

a measurer that measures signal propagation delay time of the plurality of cables,

in which the plurality of communication units adjusts transmission timing of the plurality of first signals to be transmitted to the plurality of cables on the basis of a measurement result of the measurer.

(11) The communication apparatus according to (10), further including:

a precision time base (PTB) counter that generates time stamp information to be commonly used with a communication partner apparatus,

in which the measurer measures the signal propagation delay time of the plurality of cables in synchronization with the time stamp information.

(12) The communication apparatus according to (10) or (11), in which the plurality of communication units advances, to a larger degree, timing to transmit a corresponding first signal to the cable for a cable having a longer signal propagation delay time among the plurality of cables on the basis of a measurement result of the measurer.

(13) A communication apparatus including:

a plurality of communication units that transmits a plurality of first signals to a plurality of cables and receives a plurality of second signals by the plurality of cables, in a time division duplex (TDD) communication method,

in which the plurality of communication units includes a plurality of scramblers that generates the plurality of first signals in which timing at which logic of a plurality of transmission signals changes is randomized,

each of the plurality of scramblers includes

a first initial value setting unit that sets a first initial value different for each of the plurality of first signals,

a first random number generation unit that generates a first pseudo random number on the basis of the first initial value, and

a first logical operation unit that generates a corresponding one of the first signals by logical operation of the transmission signal that corresponds and the first pseudo random number that corresponds.

(14) The communication apparatus according to (13), in which the first initial value setting unit sets the first initial value that is same as an initial value that a communication partner apparatus that has received a corresponding one of the first signals uses to restore an original transmission signal.

(15) The communication apparatus according to (13) or (14),

in which the plurality of communication units includes a plurality of descramblers that performs decoding processing on the plurality of second signals, and

each of the plurality of descramblers includes

a second initial value setting unit that sets a second initial value different for each of the plurality of second signals,

a second random number generation unit that generates a second pseudo random number on the basis of the second initial value, and

a second logical operation unit that generates a corresponding reception signal by logical operation of a corresponding one of the second signals and the second pseudo random number that corresponds.

(16) The communication apparatus according to (15), in which the second initial value setting unit sets the second initial value same as an initial value that a communication partner apparatus having transmitted a corresponding one of the second signals uses to generate the second signal.

(17) A communication system including:

a first communication apparatus; and

a second communication apparatus that alternately transmits and receives information to and from the first communication apparatus within a period allocated by a time division duplex (TDD) communication method,

in which each of the first communication apparatus and the second communication apparatus includes

a plurality of communication units that transmits a plurality of first signals to a plurality of cables at different times and receives a plurality of second signals via the plurality of cables at different times.

Aspects of the present disclosure are not limited to the above-described individual embodiments, but include various modifications that can be conceived by those skilled in the art, and the effects of the present disclosure are also not limited to the above-described content. That is, various additions, changes, and partial deletions can be made in a range without departing from the conceptual idea and spirit of the present disclosure derived from the content defined in the claims and equivalents thereof.

### REFERENCE SIGNS LIST

100 Image sensor
200 Device
200-1, 200-12, 200-13, 200-14SerDes device
200-10 Aggregator
200-10-1 Demultiplexer
200-10-2 Multiplexer
200-10-3 Buffer memory
200-1-1 Down link Tx
200-1-1-1 Scrambler
200-1-1-1a Pseudo random pattern generator
200-1-1-1b Operator
200-1-1-2 Mapper
200-1-1-3 Driver
200-1-1-4 Initial value register
200-1-14-4 Initial value register
200-1-2 Up link Rx
200-1-2-1 Descrambler
200-1-2-3 Receiver
200-14-1 Down link Tx
200-2 LINK
200-21 First measurer
200-2-1 Frame constructor
200-22 PTB counter
200-3 Application stream encapsulator
200-4 Application stream de-encapsulator
200-5, 200-6, 200-7, 200-8 Timing counter
300, 302, 303, 304 Transmission cable
400-1, 400-12, 400-13, 400-14SerDes device
400-10 Aggregator
400-10-1 Demultiplexer
400-10-2 Multiplexer
400-10-3 Buffer memory
400-1-1 Up link Tx
400-1-1-1 Scrambler
400-1-1-3 Driver
400-1-2 Down link Rx
400-12-1 Up link Tx
400-1-2-1 Descrambler
400-1-2-2 De-mapper
400-1-2-3 Receiver
400-1-2-4 Initial value register
400-13-1 Up link Tx
400-14-1 Up link Tx
400-14-2 Down link Rx
400-14-2-4 Initial value register
400-2 LINK
400-21 Second measurer
400-2-1 Frame constructor
400-2-2 Frame de-constructor
400-3 Application stream encapsulator
400-4 Application stream de-encapsulator
400-4 Application stream de-encapsulator
400-5 Timing counter

1. A communication apparatus comprising: a plurality of communication units that transmits a plurality of first signals to a plurality of cables at different times and receives a plurality of second signals via the plurality of cables at different times, in a time division duplex (TDD) communication method.

2. The communication apparatus according to claim 1, wherein the plurality of communication units causes timings to transmit the plurality of first signals to the plurality of cables to be different, and causes timings to receive the plurality of second signals from the plurality of cables to be different.

3. The communication apparatus according to claim 1, wherein, using a corresponding one of the cables, each of the plurality of communication units transmits, in a first signal section, a corresponding one of the first signals, and receives, in a second signal section, a corresponding one of the second signals.

4. The communication apparatus according to claim 1, wherein the plurality of communication units sequentially shifts the plurality of first signals by a predetermined time difference and transmits the plurality of first signals to the plurality of cables.

5. The communication apparatus according to claim 4, wherein the predetermined time difference is a same time difference.

6. The communication apparatus according to claim 4, wherein the predetermined time difference includes two or more time differences having different time lengths.

7. The communication apparatus according to claim 1, further comprising: a plurality of temporary storage units that adjusts variations in reception timing of the plurality of second signals received by the plurality of communication units.

8. The communication apparatus according to claim 7, wherein a storage capacity of each of the plurality of temporary storage units varies according to signal propagation delay time of a corresponding one of the cables.

9. The communication apparatus according to claim 7, wherein the plurality of temporary storage units adjusts variation in signal propagation delay time of the plurality of cables.

10. The communication apparatus according to claim 1, further comprising:
a measurer that measures signal propagation delay time of the plurality of cables,
wherein the plurality of communication units adjusts transmission timing of the plurality of first signals to be transmitted to the plurality of cables on a basis of a measurement result of the measurer.

11. The communication apparatus according to claim 10, further comprising:
a precision time base (PTB) counter that generates time stamp information to be commonly used with a communication partner apparatus,
wherein the measurer measures the signal propagation delay time of the plurality of cables in synchronization with the time stamp information.

12. The communication apparatus according to claim 10, wherein the plurality of communication units advances, to a larger degree, timing to transmit a corresponding first signal to the cable for a cable having a longer signal propagation delay time among the plurality of cables on a basis of a measurement result of the measurer.

13. A communication apparatus comprising:
a plurality of communication units that transmits a plurality of first signals to a plurality of cables and receives a plurality of second signals by the plurality of cables, in a time division duplex (TDD) communication method,
wherein the plurality of communication units includes a plurality of scramblers that generates the plurality of first signals in which timing at which logic of a plurality of transmission signals changes is randomized,
each of the plurality of scramblers includes
a first initial value setting unit that sets a first initial value different for each of the plurality of first signals,
a first random number generation unit that generates a first pseudo random number on a basis of the first initial value, and
a first logical operation unit that generates a corresponding one of the first signals by logical operation of the transmission signal that corresponds and the first pseudo random number that corresponds.

14. The communication apparatus according to claim 13, wherein the first initial value setting unit sets the first initial value that is same as an initial value that a communication partner apparatus that has received a corresponding one of the first signals uses to restore an original transmission signal.

15. The communication apparatus according to claim 13,
wherein the plurality of communication units includes a plurality of descramblers that performs decoding processing on the plurality of second signals, and
each of the plurality of descramblers includes
a second initial value setting unit that sets a second initial value different for each of the plurality of second signals,
a second random number generation unit that generates a second pseudo random number on a basis of the second initial value, and
a second logical operation unit that generates a corresponding reception signal by logical operation of a corresponding one of the second signals and the second pseudo random number that corresponds.

16. The communication apparatus according to claim 15, wherein the second initial value setting unit sets the second initial value same as an initial value that a communication partner apparatus having transmitted a corresponding one of the second signals uses to generate the second signal.

17. A communication system comprising:
a first communication apparatus; and
a second communication apparatus that alternately transmits and receives information to and from the first communication apparatus within a period allocated by a time division duplex (TDD) communication method,
wherein each of the first communication apparatus and the second communication apparatus includes
a plurality of communication units that transmits a plurality of first signals to a plurality of cables at different times and receives a plurality of second signals via the plurality of cables at different times.
